(19) United States
(12) Patent Application Publication
(10) Pub. No.: US 2022/0142071 A1
(43) Pub. Date: May 12, 2022

(54) HYDROPONIC SYSTEM WITH REGULATORY BACK FLOW PREVENTION DEVICE

(71) Applicant: James Poore, Lakeland, FL (US)

(72) Inventor: James Poore, Lakeland, FL (US)

(21) Appl. No.: 17/334,737

(22) Filed: May 29, 2021

Related U.S. Application Data
(60) Provisional application No. 63/032,545, filed on May 30, 2020.

(51) Int. Cl. A01G 31/02

(52) U.S. Cl. CPC A01G 31/02

(57) ABSTRACT

A hydroponics system with regulatory back flow prevention device that keeps the water in a plant bed from draining is described.

### RELATED APPLICATIONS

This application claims the benefit of U.S. Provisional Application No. 63/032,545, entitled “Hydroponic System With Regulatory Back Flow Prevention Device,” and filed on May 30, 2020, which is incorporated herein by reference in its entirety.

### TECHNICAL FIELD

Some implementations relate generally to a hydroponic growing system and more particularly to an inline apparatus which prevents water from draining out of the plant bed in the event of a pump malfunction or a pipe leak.

### BACKGROUND

Hydroponics is the art of growing plants without soil and has been practiced for many years. Most hydroponics growing systems usually includes some type of an enclosure or plant bed filled with an artificial soil (growing medium) and a water supply system. The water supply system usually consists of a water supply tank, a pump, and a piping system. This water supply system circulates the water and nutrients to the plant beds. The plant beds can be elevated at a level that is above the water supply tank. In some conventional systems, if the pump malfunctions or a pipe leaks, this could cause the water to back flow and drain out of the plant beds. If such a problem is not noticed in a timely manner it could result in the crop being destroyed.

### SUMMARY

Some implementations can include a hydroponic system with regulatory back flow prevention device. The system can include a tank constructed to supply hydroponic fluids such as water or water with nutrients, and a regulator having a supply inlet line, an overflow pipe, a tank return line, an outlet line, a water circuit breaker, and a back flow prevention pipe, wherein the back flow prevention pipe having a first end a second end, wherein the back flow prevention pipe includes a 180 degree loop, wherein the first end of the back flow prevention pipe is inserted firmly into the supply inlet line and the second end is inserted into the outlet line and forms the water circuit breaker where an outer wall of the back flow prevention pipe has a diameter less than an inner diameter of the outlet line creating a gap at that connection, wherein this gap permits air into the back flow prevention pipe when a water level drops below a given level, and wherein the 180 degree loop extends higher that the overflow pipe. The system optionally includes a plant bed.

The system can further include a flag, a float, and a regulator cap, where the regulator cap has a small aperture, and the flag is routed through the small aperture of the regulator cap and attached to the float to visually indicate a level of water within the regulator. Some implementations can include a sensor and light and or alarm.

Some implementations can include a hydroponic system with regulatory back flow prevention device. The system can include a tank constructed to supply hydroponic fluids such as water or water with nutrients, and a first regulator having a supply inlet line, an overflow pipe, a tank return line, an outlet line, a water circuit breaker, a back flow prevention pipe. The system can also include a second regulator having a supply inlet line, an overflow pipe, a tank return line, an outlet line, a water circuit breaker, a back flow prevention pipe, and an optional plant bed.

In some implementations, the system can also include a flag, a float, and a regulator cap, where the regulator cap having a small aperture and where the flag is routed through the small aperture of the regulator cap and attached to the float. In some implementations, the system can include a water level sensor and an alert indicator configured to indicate a water level below a given level.

Some implementations can include a regulatory back flow prevention device having a regulator having a supply inlet line, an overflow pipe, a tank return line, an outlet line, a water circuit breaker, and a back flow prevention pipe. In some implementations, the regulatory back flow prevention device can also include a flag, a float, and a regulator cap, where the regulator cap having a small aperture and where the flag is routed through the small aperture of the regulator cap and attached to the float. In some implementations, the regulatory back flow prevention device includes a water level sensor and a visual or audible indicator.

### BRIEF DESCRIPTION OF THE DRAWINGS

FIG. 1 is a diagram of a system view of an example hydroponics system with regulatory back flow prevention device in accordance with some implementations.

FIG. 2 is a diagram showing a side view with hidden lines of internal features of an example regulatory back flow prevention device in accordance with some implementations.

FIG. 3 is a diagram of a system view of an example hydroponics system with dual regulatory back flow prevention devices in accordance with some implementations.

### DETAILED DESCRIPTION

Some implementations can include a hydroponics system with back flow prevention device. The hydroponics system can include one or more pumps to supply water and nutrients to the plant bed. Each pump connects to the plant bed via a regulator with a regulatory back flow prevention device that controls the water supply to, and draining of, the plant bed. An overflow pipe inside the regulator sets the maximum water level to be supplied to the plant bed so that it does not overflow. A back flow prevention pipe inside the regulator having one end that is designed to take in air while at the end of the draining process once the desired minimum water level is met, this acts as a water circuit breaker and has two functions. The first function operates in a system with one pump. After a drain cycle is complete, the back flow prevention pipe will take in air when the water level in the bed drains to a selected minimum water level acting as a water circuit breaker. This is designed to prevent the plant bed from draining completely and drying out, which could result in the loss of the crop.

The second function operates when two or more-pumps are used in a system. After a drain cycle is completed by a first pump, the back flow prevention pipe will take in air when it drains to a selected minimum water level acting as a water circuit breaker. This is designed to prevent the plant bed from draining completely and drying out, which could result in the loss of the crop. This will also permit a second pump in the system to fill the plant bed to the maximum water level (e.g., the top of the overflow pipe) and keep it from draining back through the back flow prevention pipe inside the regulator connected to the first pump causing the level to not raise above the minimum water level. This also keeps the plant bed at the minimum water level in the event that one or both of the pumps fail (e.g., either a normal drain cycle is completed, and the pump fails on next start up or a loss of power during a supply cycle and a reverse flow or gravity drain occurs).

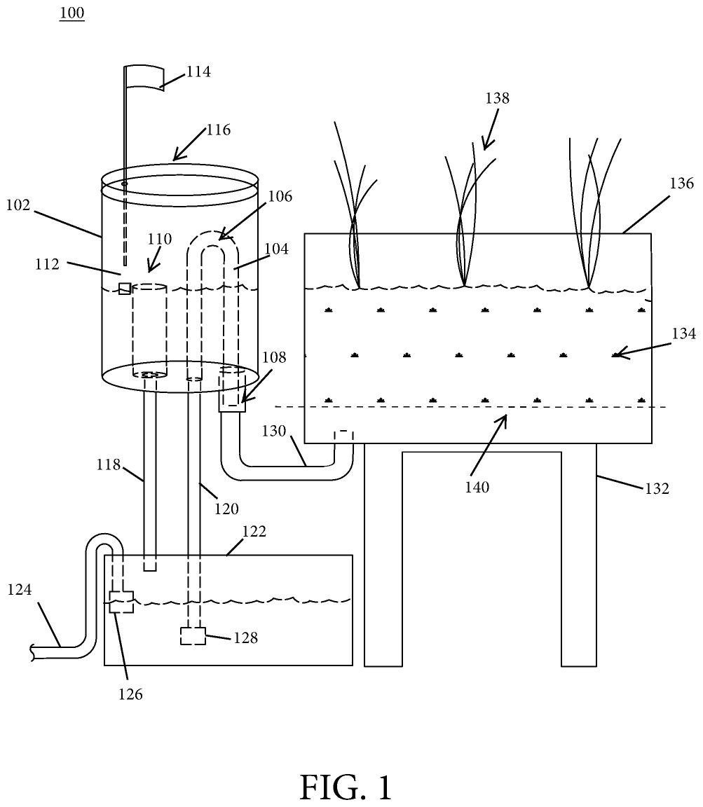

FIG. 1 is a diagram of a system view of an example hydroponics system with regulatory back flow prevention device in accordance with some implementations. The hydroponics system with regulatory back flow prevention device 100 includes a tank 122, a regulator 102, a plant bed 136, and a table stand 132.

The regulator 102 having a supply inlet line 120, an overflow pipe 110, a tank return line 118, an outlet line 130, a water circuit breaker 108, a back flow prevention pipe 104, a loop 106, a float 112, a flag 114, and a. regulator cap 116.

The tank 122 includes a water source inlet 124 with a float switch 126 to turn on and off the water supply and a submersible pump 128. In some implementations, the system can operate in a cycle in which the pump is operated in a first direction to fill the plant bed 136 with liquid to a given level (e.g., the level of the overflow pipe 110) for a first period of time and then reversed to drain the bed of liquid down to a second level (e.g., the level of 140) for a second period of time. The cycles can repeat periodically (e.g., every hour, etc.). Also, when the pump is off, the liquid level in the plant bed 136 can drain down to the level 140 and air will be taken up in the back flow prevention pipe 104 at 108. Liquid level 140 is a level that maintains some liquid in the plant bed 136 to prevent the bed from drying out completely.

The plant bed 136 sits on a table stand 132. The plant bed 136 having a growing medium 134 to act as the soil for the plants 138.

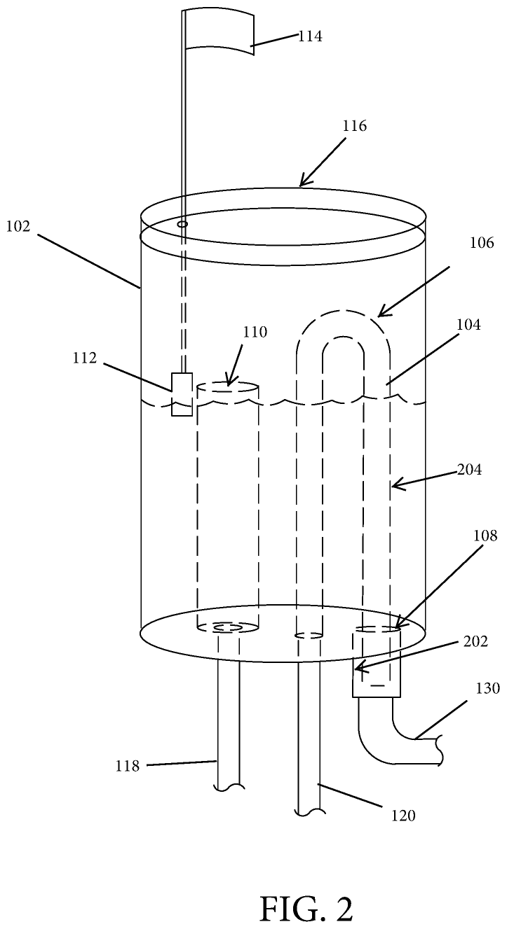

FIG. 2 is a diagram showing a side view with hidden lines of internal features of an example regulatory hack flow prevention device in accordance with some implementations. The regulatory back flow prevention device includes a regulator 102, a supply inlet line 120, an overflow pipe 110, a tank return line 118, an outlet line 130, an inner wall 202, an outer wall 204, a water circuit breaker 108, a back flow prevention pipe 104, a loop 106, a float 112, a flag 114, and a regulator cap 116.

The regulator 102 having a cylindrical shape with three openings (an overflow pipe 110, a back flow prevention pipe 104, and an outlet line 130) on the bottom end. The regulator 102 also includes a regulator cap 116 on the top end.

The height of the overflow pipe 110 determines the maximum level of the water in the plant bed 136 by returning the water back to the tank 122 and not allowing the water level to rise above the overflow pipe 110 while the pump is in a run (or fill) cycle.

One end of the back flow prevention pipe 104 is inserted firmly into the supply inlet line 120 and the opposite end is inserted into the outlet line 130 with the outer wall 204 of the back flow prevention pipe 104 having a diameter less than the inner wall 202 of the outlet line 130 and creates a gap at that connection called the water circuit breaker 108. This gap permits air to be introduced into the system when drained to this level causing it to lose its suction prime. This would keep the reverse flow from draining the plant bed 136 below the level 140.

The loop 106 on the back flow prevention pipe 104 extends above the height of the overflow pipe 110 and does not permit a back flow to occur once air has been introduced into the system (e.g., a second pump will only be able to fill the regulator 102 up to the overflow pipe 110 and not travel down the back flow prevention pipe 104 due to the loop 106 extending above the height of the overflow pipe 110).

The flag 114 that extends through a hole in the regulator cap 116 and is attached to a float 112. The flag 114 provides a visual indication of the water level in the regulator 102. In some implementations, the float could be replaced with a sensor and the flag 114 could be replaced with a LED and or an alarm that provides a signal indicating a problem when one or more of the pumps are activated but the float or other sensor does not indicate a water level rise to a given threshold level,

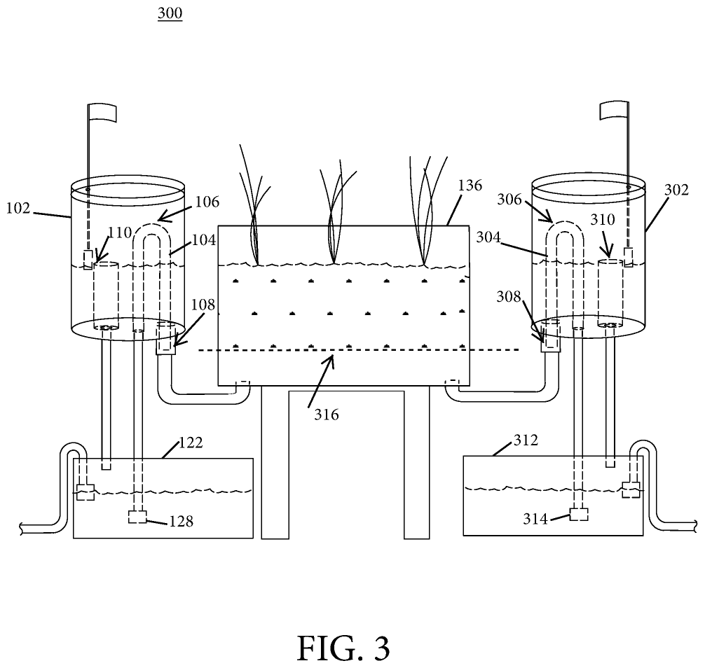

FIG. 3 is a diagram of a system view of an example hydroponics system with duel regulatory back flow prevention devices in accordance with some implementations. The environment in FIG. 3 includes a second hydroponics system with regulatory back flow prevention device (similar to 100 described above) that includes a tank 322, a regulator 302.

The regulator 302 includes a supply inlet line 320, an overflow pipe 310, a tank return line 318, an outlet line 330, a water circuit breaker 308, a back flow prevention pipe 304, and a loop 306. The second hydroponics system operates in a manner similar to that described above regarding 100,

In a system with dual pumps, the backflow prevention devices (104 or 304) have loops (106 or 306, respectively) that extend above the height of the overflow pipe 110/310 and also extend above the water level to create an air space in the water circuit after an initial drain. This air space causes the backflow to lose its suction prime. This would keep the reverse flow or failed pump from draining the plant bed below the level 140 while still operating such that the second system can still fill the plant bed to the level of the overflow pipe 110/310 without the liquid being drained out at the reverse flow or failed pump side.

In some implementations, a large system can include the flag indicator or electronic sensor indicator to indicate that a pump is not running and can include two pumps on the system. For example, a larger garden system can include a system that is 4 ft wide by 8 ft long. Some implementations can include more or less components described herein. For example, a smaller garden system can include a 2 ft by 3 ft garden or a 2 ft by 8 ft garden. In another example, a larger garden system can include a garden 4 ft×8 ft or 4 ft×16 ft. Such larger system can include a full set of components as described herein, including dual pumps. In some implementations, the gardens can go without power and fluid for 2 to 3 days up to 7 days depending on what is being grown in the gardens.

It is, therefore, apparent that there is provided, in accordance with the various embodiments disclosed herein, hydroponics system with regulatory hack flow prevention device.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A hydroponic system with regulatory back flow prevention device comprising:
a tank constructed to supply hydroponic fluids such as water or water with nutrients;
a regulator having a supply inlet line, an overflow pipe, a tank return line, an outlet line, a water circuit breaker, and a back flow prevention pipe, wherein the back flow prevention pipe having a first end a second end, wherein the back flow prevention pipe includes a 180 degree loop, wherein the first end of the back flow prevention pipe is inserted firmly into the supply inlet line and the second end is inserted into the outlet line and forms the water circuit breaker where an outer wall of the back flow prevention pipe has a diameter less than an inner diameter of the outlet line creating a gap at that connection, wherein this gap permits air into the back flow prevention pipe when a water level drops below a given level, and wherein the 180 degree loop extends higher that the overflow pipe; and
a plant bed.

2. The hydroponic system with regulatory back flow prevention device of claim 1, further comprising a flag, a float, and a regulator cap, wherein the regulator cap having a small aperture, wherein the flag is routed through the small aperture of the regulator cap and attached to the float.

3. The hydroponic system with regulatory back flow prevention device of claim 2, wherein the float and flag replaced with a sensor and light and or alarm.

4. A hydroponics system with regulatory back flow prevention device comprising:
a tank constructed to supply hydroponic fluids such as water or water with nutrients;
a first regulator having a supply inlet line, an overflow pipe, a tank return line, an outlet line, a water circuit breaker, a back flow prevention pipe;
a second regulator having a supply inlet line, an overflow pipe, a tank return line, an outlet line, a water circuit breaker, a back flow prevention pipe; and
a plant bed.

5. The hydroponic system with regulatory back flow prevention device of claim 4, further comprising a flag, a float, and a regulator cap, wherein the regulator cap having a small aperture, wherein the flag is routed through the small aperture of the regulator cap and attached to the float.

6. The hydroponic system with regulatory back flow prevention device of claim 4, further comprising a water level sensor and an alert indicator configured to indicate a water level below a given level.

7. A regulatory back flow prevention device comprising:
a regulator having a supply inlet line, an overflow pipe, a tank return line, an outlet line, a water circuit breaker, and a back flow prevention pipe.

8. The regulatory back flow prevention device of claim 7, further comprising a flag, a float, and a regulator cap, wherein the regulator cap having a small aperture, wherein the flag is routed through the small aperture of the regulator cap and attached to the float.

9. The regulatory back flow prevention device of claim 7, further comprising a water level sensor and a visual or audible indicator.
